(19) United States
(12) Patent Application Publication
(10) Pub. No.: US 2010/0196174 A1
(43) Pub. Date: Aug. 5, 2010

(54) IPM MOTOR AND VACUUM INHALING APPARATUS USING THE SAME

(75) Inventor: Jong Hoon Lee, Incheon (KR)

Correspondence Address: CANTOR COLBURN, LLP, 20 Church Street, 22nd Floor, Hartford, CT, 06103, US

(73) Assignee: AMOTECH CO., LTD., Incheon (KR)

(21) Appl. No.: 12/676,109

(22) PCT Filed: Sep. 8, 2008
(86) PCT No.: PCT/KR08/05296

§ 371 Date: Mar. 2, 2010

(30) Foreign Application Priority Data
Sep. 18, 2007 (KR) 10-2007-0094665

(51) Int. Cl. F04D 25/06; H02K 21/14

(52) U.S. Cl. 417/410.1; 310/156.53

(57) ABSTRACT

Provided is a high speed and high efficiency IPM (Interior Permanent Magnet) motor and a slim type vacuum inhaling apparatus using the same, which establishes a passage path of introduced air into a path of air-cooling the inside of a stator and a circuit element to thus cool heat that is produced from the IPM motor without a special heat radiator. The IPM motor includes: a stator having a number of tees which are protruded so as to form a number of slots on the inner circumferential wall of a cylindrical body, and a stator coil which is partially wound around the slots; and an IPM type rotor having a rotor core at the central side of which a rotating shaft is mounted, and a number of permanent magnets which are fitted into a number of permanent magnet insertion holes which are formed on the identical circumference of the rotor core, and which is rotated by the stator.

### TECHNICAL FIELD

This invention relates to an IPM (Interior Permanent Magnet) motor and a vacuum inhalation apparatus using the same, and more particularly, to a high speed and high efficiency IPM motor and a slim type vacuum inhaling apparatus using the same, which employs the IPM motor having little heat generation by electric current in the inside of a rotor and establishes a passage path of introduced air into a path of air-cooling the inside of a stator and a circuit element to thus cool heat that is produced from the IPM motor without a special heat radiator.

### BACKGROUND ART

Today, a number of electric home appliances are being developed and marketed. Among the number of electric home appliances, a vacuum cleaner is developed for cleanliness of a residence environment.

Vacuum cleaners are electric appliances which inhale air including foreign matters such as dust using a vacuum pressure generated by an impeller and a BLDG (brushless DC) motor that are installed in the inside of a main body of the vacuum cleaner, and filter the foreign matters in the inside of the main body.

The vacuum cleaner needs to employ low electric power consumption and high efficiency BLDG motor in a vacuum generation apparatus in order to generate a vacuum pressure.

The BLDC motor needs a driver including an electric power drive element, and requires for a heat radiation countermeasure for quickly radiating heat generated from the electric power drive element, in order to produce high power of 100 W or more. As described above, in order to radiate heat generated from the vacuum cleaner, separate heat radiating fins should be provided or the BLDC motor should be surrounded, or a housing in which the BLDC motor is mounted should be formed of metal of a high conductivity such as aluminum.

Therefore, since a conventional vacuum inhalation apparatus performs a heat radiation operation with a structure that an electric power drive element of the BLDC motor is attached to a radiating fin or a radiating housing, it is difficult to employ a slim type structure that the BLDC motor is closely attached to an air guide of the vacuum inhalation apparatus. That is, it was not possible to design the drive motor into an internal type that makes a drive motor located in a space between the air guide and a control PCB.

In addition, in the case that a heat radiating structure such as a heat radiating fin or a heat radiating housing is provided in order to cool heat generated from the BLDC motor, the heat radiating structure should be mounted in the inside of the vacuum inhalation apparatus of the cleaner. Accordingly, the internal structure of the cleaner becomes complicated. Further, size of the vacuum inhalation apparatus becomes large due to the space in which the heat radiating structure is mounted. In addition, in the case that the housing of the BLDC motor is formed of the heat radiating structure, weight of the vacuum inhalation apparatus becomes increased. As a result, electric power consumption is caused to increase.

Therefore, heat radiation elements are required to efficiently cool heat that is produced from the vacuum inhalation apparatus of the cleaner. Through the heat radiation elements, it is required to make size of the cleaner compact and simultaneously reduce weight of the cleaner.

Further, the cleaner need to maximize an inhalation force and an inhalation efficiency of inhaling air to clean a wide area with high cleanness and in short time basically. Therefore, in order to maximize a cleaning efficiency of the cleaner, the power and rotational force of a motor for a vacuum inhalation apparatus which inhales air should be maximized. However, the power and rotational force of the motor which is applied to the conventional vacuum inhalation apparatus does not reach a required level and further electric power consumption becomes large. According to the conventional art, it is difficult to implement a BLDG motor which produces a high speed and large output of 30,000 rpm or more and 1 Kw or more.

Meanwhile, according to the conventional art, the central portion of the impeller has a structure of compressively being supported to a rotor bushing by an impeller bushing whose diameter is small. By this structure, the rotational force of the rotor is transferred via the central portion of the impeller. As a result, there is a problem that the rotational force of the rotor is not effectively delivered to the impeller because the impeller slides from the rotational shaft during rotation of the rotor.

In addition, an IPM (Interior Permanent Magnet) type BLDG motor where a permanent magnet is inserted in the inside of a rotor, or a SPM (Surface Permanent Magnet) type BLDG motor that a permanent magnet is attached on the surface of a rotor is used as a BLDC motor. In this case, the IPM type BLDG motor that cannot only prevent the permanent magnet from being scattered by a centrifugal force at high speed rotation and prevent a neodymium (Nd) magnet from being rust, but can also generate big torque is chiefly used for high speed rotation.

The conventional IPM type BLDC motor includes: a stator that has a space at the center thereof; and a rotor which is rotatably arranged at a predetermined interval in the space at the center of the stator.

The stator includes: a stator core formed at the outside thereof; a number of tees which are projected in a “T” shape at a given interval in the circumferential direction of the central space of the stator core and between which a number of slots are formed; and a stator coil that is wound around the tees.

The rotor includes: a rotor core at the center of which a rotating shaft is installed; and a number of permanent magnets which have respectively different poles and installed at an equal interval, in the circumferential direction of the rotor core. The permanent magnets are inserted in a space where a spacer having a given space is formed at the ends of both sides thereof having respectively different polarities. Here, the spacer enlarges magnetoresistance and prevents flux leakage, by the given space which is formed at the ends of both the sides of the permanent magnets, respectively.

The above-described conventional IPM type BLDC motor generates torque ripple if electric power is applied to the stator coil. Change of gap flux density and distortion of electric current necessarily exist by the torque ripple. Accordingly, cogging torque and reluctance torque ripple occur.

That is, when a rotor is rotated, magnetic reluctance in a space where the rotor is rotated is large. Accordingly, most of the magnetic fluxes pass through a core portion whose magnetoresistance is small, and the core portion has a gap magnetic density that is not similar to a sine wave. As a result, since energy changes are further enlarged according to change in an angle of rotation, cogging torque is grown.

Here, the cogging torque is a non-uniform torque of a stator, and represents a tangential force by which a motor system moves to a position where magnetic energy is minimum. In other words, the cogging torque represents a reluctance torque which occurs in an air gap between the outer diameter of the rotor and the inner diameter of the stator when magnetic energy occurs regardless of a load current. The cogging torque necessarily occurs in a permanent magnet type motor and becomes a cause of vibration noise in the motor.

Korean Patent No, 416771 proposed an IPM type BLDC motor which includes: a stator at the central side of which a stator slot is formed at a given interval; and a rotor where a plurality of permanent magnets that have different poles are inserted in a space formed between a pole shoe and a link and web on the inner surface of the stator, wherein the pole shoe constitutes an air gap space at the outer side thereof, and has a pole shoe protrusion which contacts a non-magnetic medium such as the space and air at the outer side thereof, so that part of the magnetic fluxes that pass the permanent magnets can be leaked through the space.

The IPM type BLDC motor includes the pole shoe protrusion which contacts the space formed at the lower end of the pole shoe so that part of the magnetic fluxes generated from the permanent magnets can be leaked through the space, to thus have a gap magnetic flux density which is similar to a sine wave, to thereby reduce a cogging torque and to thus reduce vibration and noise of the motor.

Korean Patent No. 436147 proposed a burial type permanent magnet motor which improves shape of a permanent magnet which is buried in a rotor, to thus make a magnetic flux density distribution in a gap between a stator and a rotor uniform, and to thereby enhance an efficiency of the motor, as well as reduce a torque ripple.

For this purpose, in the case of the rotor where a plurality of permanent magnets are buried in a core in the Korean Patent No. 436147, each permanent magnet includes an inner circumferential surface which is formed convexly at a given curvature toward the center of the core, and an outer circumferential surface which is formed convexly at a given curvature toward the circumferential surface of the core, wherein the outer circumferential surface includes a first curved portion extended from both ends of the inner circumferential surface and having a certain curvature, and a second curved portion which connects both ends of the first curved portion and having a curvature larger than that of the first curved portion.

The above-described conventional IPM type BLDC motor has a structure having multiple slots and multiple poles where a number of N-poles and S-poles are arranged alternately. If an air path for discharging introduced air having passed through an impeller is designed at the outer side of the motor, in the case that such a structure is applied in a vacuum inhaling apparatus, a housing of the vacuum inhaling apparatus becomes large, and heat radiation counter-measurement should be separately prepared. In addition, there is a problem of causing a big change of a motor structure when the air path is formed in the inside of the motor.

### DISCLOSURE

### Technical Problem

To solve the above problems, it is an object of the present invention to provide an IPM (Interior Permanent Magnet) motor and a slim type vacuum inhaling apparatus which employs the IPM motor to thus cause little heat generation by an electric current flowing in the inside of a rotor and which establishes a path through which introduced air passes into a path which air-cools the inside of a stator and circuit elements, to thus cool the vacuum inhaling apparatus without a separate heat radiator.

It is another object of the present invention to provide a vacuum inhaling apparatus which is designed to make a path through which external air inhaled by vacuum passes shortened as well as curved so that frictional resistance becomes small, to thereby make an inhalation efficiency increased and electric power consumption reduced, and to accordingly easily cool heat that is produced from an electric power drive component.

It is still another object of the present invention to provide an IPM (Interior Permanent Magnet) motor and a slim type vacuum inhaling apparatus which employs the IPM motor in which a structure of having a small number of slots is employed so that a path through which introduced air passes can pass through the inside of a stator, and thus a structure of a magnetic circuit with respect to a rotor of the IPM motor is changed so as to correspond to the structure of the stator, to thereby achieve a high efficiency and miniaturization.

It is yet another object of the present invention to provide a high efficiency vacuum inhaling apparatus which employs an IPM (Interior Permanent Magnet) motor which has a good efficiency in a big torque region to thus enable miniaturization of the motor, and thus which minimizes heat generation produced from the vacuum inhaling apparatus of a cleaner and miniaturizes the cleaner.

### Technical Solution

To accomplish the above object of the present invention, according to an aspect of the present invention, there is provided a vacuum inhaling apparatus comprising: a vacuum inhaling apparatus comprising: an IPM (Interior Permanent Magnet) motor including: a stator having a number of tees which are protruded so as to form a number of slots on the inner circumferential wall of a cylindrical body, and a stator coil which is partially wound around the slots; and an IPM (Interior Permanent Magnet) type rotor having a rotor core which is rotatably disposed spaced by a certain gap in the inside of the stator, and a number of permanent magnets which are fitted into a number of permanent magnet insertion holes which are formed on the circumference of the rotor core, and which is rotated by the stator; a cylindrical upper housing which protects the upper portion and the outer circumferential surface of the IPM motor and which has a number of first throughholes through which introduced air passes; an intermediate housing whose outer circumferential portion is combined with the lower end of the upper housing, and which supports the IPM motor and which has a number of second throughholes through which the introduced air passes; a rotating shaft which is fixedly combined at the center of the rotor core and whose both ends are rotatably supported to the upper and intermediate housings; an impeller which is arranged at the upper side of the upper housing, and whose lower plate is fixedly combined on the upper end of the rotating shaft, to thus generate an inhalation force via a first circular inlet located at the center of the upper plate of the impeller by a number of spiral guide vanes as the rotating shaft is rotated; a cover at the upper end of which has a second circular inlet corresponding to the first circular inlet of the impeller, and whose lower end is fixedly combined with the upper housing while surrounding the impeller to thus guide the introduced air in the central direction; and an air guide which is arranged between the impeller and the upper housing, and which guides the introduced air guided in the central direction into the first throughholes of the upper housing, wherein the introduced air guided into the first throughholes of the upper housing is exhausted via the second throughholes of the intermediate housing through the central space of slots around which the stator coil is not wound.

Preferably but not necessarily, an annular protrusion which guides the introduced air guided in the central direction into the first throughholes of the upper housing, by the air guide, and on the inner circumferential portion of which a first bearing accommodation groove is formed in the vacuum inhaling apparatus, is protrudingly formed from the center of the upper housing to the center of the air guide, and the vacuum inhaling apparatus further comprises: a first bearing which is accommodated in the first bearing accommodation groove, to thus rotatably support one side of the rotating shaft; and a second bearing which is accommodated in a second bearing accommodation groove that is provided in the intermediate housing, to thus rotatably support the rotating shaft.

Preferably but not necessarily, the vacuum inhaling apparatus further comprises: first and second impeller washers which are fixed on the upper and lower surfaces of the lower plate of the impeller, respectively, and at the central portion of which the rotating shaft is combined; a poly slider which is inserted between the second impeller washer and the second bearing and into the central portion of which the rotating shaft is inserted; an impeller bushing which is combined on the upper portion of the first impeller washer and into the central portion of which the rotating shaft is inserted; a fixing nut which screw-combined on the upper portion of the rotating shaft, wherein the impeller bushing compressively supports the first and second impeller washers to the central portion of the lower plate of the impeller according to tightening of the fixing nut, and is closely fixed rotatably to the first bearing through the poly slider.

Preferably but not necessarily, the vacuum inhaling apparatus further comprises: a control PCB (Printed Circuit Board) on which circuit elements of a drive circuit which applies a drive voltage for the IPM motor are mounted; a PCB cover on the bottom of which the control PCB is installed, and a number of legs vertically extended from the outer circumferential portion of which are combined with the intermediate housing, and which makes the introduced air flowing via the slots of the stator and the second throughholes of the intermediate housing cool the circuit elements and then exhausted via outlets formed between the legs.

Preferably but not necessarily, the vacuum inhaling apparatus further comprises: first and second balance weights which are made of a non-magnetic material, respectively, and are respectively installed at both ends of the rotor so that the permanent magnets do not secede externally, to thus be used for preventing an eccentricity during high speed rotation of the motor; a sensing magnet which is fixedly combined with a sensing magnet bracket which is installed at the lower end of the second balance weight, and which is magnetized in an identical pole at an identical position to those of the rotor, to thus be used for detecting a rotational position of the rotor; and a hall sensor which is installed in the intermediate housing opposing the sensing magnet to detect a rotational position of the rotor from the sensing magnet.

Preferably but not necessarily, a number of elongate holes are formed on the outer circumferential portion of the intermediate housing, and a position where the intermediate housing is combined with the upper housing is adjusted using the elongate holes, in order to determine a timing at which the hall sensor detects the rotational position of the rotor, in which the timing at which the hall sensor detects the rotational position of the rotor is established so that a drive signal for the stator coil can be applied at a timing at which the smallest amount of electric current flows in the stator coil.

Preferably but not necessarily, the number of the permanent magnets comprise a first group of four permanent magnets whose circumferential surfaces are diametrically magnetized into an N-pole and arranged adjacently one another, and a second group of four permanent magnets whose circumferential surfaces are diametrically magnetized into an S-pole and arranged adjacently one another, so as to have a totally 2-pole magnetic pole structure, and first and second spacers are formed between the first group of the permanent magnets and the second group of the permanent magnets, respectively, in order to prevent leakage of magnetic flux in a circumferential direction.

Preferably but not necessarily, the number of the permanent magnets are formed of a bar shape, respectively, the outer circumferential surfaces thereof are established identically with curvatures of the outer circumferential surfaces of the permanent magnet insertion holes, respectively, in the cross-sections of the permanent magnets and the inner side surfaces opposing the outer circumferential surfaces thereof form linear shapes and have shapes corresponding to the permanent magnet insertion holes, respectively, and both side surfaces thereof are established perpendicularly with the inner side surfaces thereof.

Preferably but not necessarily, the outer circumferential surfaces of the permanent magnet insertion holes are established equally with curvatures of the curvatures of the outer circumferential surfaces of the rotor core, and the inner side surfaces opposing the outer circumferential surfaces of the permanent magnet insertion holes form linear shapes, and third and fourth spacers into which no permanent magnets are inserted are protrudingly formed in both side surfaces of permanent magnet insertion holes, in order to prevent leakage of the magnetic flux in the respective side directions.

Preferably but not necessarily, the IPM motor has a 2-pole, 3-slot structure.

Preferably but not necessarily, the first throughholes of the upper housing and the second throughholes of the intermediate housing are made of two and three in numbers, respectively, and communicate from one another by three slots of the stator.

According to another aspect of the present invention, there is also provided an IPM (Interior Permanent Magnet) motor comprising: a stator having a number of tees which are protruded so as to form a number of slots on the inner circumferential wall of a cylindrical body, and a stator coil which is partially wound around the slots; an IPM (Interior Permanent Magnet) type rotor having a rotor core which is rotatably disposed spaced by a certain gap in the inside of the stator, and at the central side of which a rotating shaft is mounted, and a number of permanent magnets which are fitted into a number of permanent magnet insertion holes which are formed on the identical circumference of the rotor core, and which is rotated by the stator; wherein the number of the permanent magnets comprise a first group of four permanent magnets whose circumferential surfaces are diametrically magnetized into an N-pole and arranged adjacently one another, and a second group of four permanent magnets whose circumferential surfaces are diametrically magnetized into an S-pole and arranged adjacently one another, so as to have a totally 2-pole magnetic pole structure, and wherein first and second spacers are formed between the first group of the permanent magnets and the second group of the permanent magnets, respectively, in order to prevent leakage of magnetic flux in a circumferential direction.

Preferably but not necessarily, the number of the slots formed in the stator are divided into first and second regions around which the stator coil is wound, respectively, and a third region formed between the first and second regions and around which the stator coil is not wound, and air is ventilated through the third region.

Preferably but not necessarily, the number of the permanent magnets are formed of a bar shape, respectively, the outer circumferential surfaces thereof are established identically with curvatures of the outer circumferential surfaces of the permanent magnet insertion holes, respectively, in the cross-sections of the permanent magnets and the inner side surfaces opposing the outer circumferential surfaces thereof form linear shapes and have shapes corresponding to the permanent magnet insertion holes, respectively, and both side surfaces thereof are established perpendicularly with the inner side surfaces thereof, and the outer circumferential surfaces of the permanent magnet insertion holes are established equally with curvatures of the curvatures of the outer circumferential surfaces of the rotor core, and the inner side surfaces opposing the outer circumferential surfaces of the permanent magnet insertion holes form linear shapes, and third and fourth spacers into which no permanent magnets are inserted are protrudingly formed in both side surfaces thereof in order to prevent leakage of the magnetic flux in the respective side directions.

Preferably but not necessarily, the IPM motor has a 2-pole, 3-slot structure, and is used as a rotational force generator for a vacuum inhaling apparatus for use in a vacuum cleaner.

### ADVANTAGEOUS EFFECTS

As described above, a vacuum inhaling apparatus according to the present invention is configured to have a curved path of the shortest distance via which external air passes in which the external air passes through a circular inlet of a cover, an impeller, an air guide, a stator of a motor, and an outlet of a PCB cover, in turn, to thus make the vacuum inhaling apparatus established to have a natural airflow channel, and to thereby minimize a frictional resistance.

In addition, introduced air having passed through an upper housing moves to the inside of a motor, to thus air-cool circuit elements such as power drive devices which are mounted on a stator and a control PCB, and an air exhaustion path is established into an outlet of the PCB cover. Accordingly, the vacuum inhaling apparatus can be cooled without having a separate heat radiator.

Moreover, a rotational force of a rotor is effectively transferred to an impeller in the vacuum inhaling apparatus according to the present invention, and thus air passes through an airflow path having a short air passage route and a small amount of frictional resistance. Accordingly, a high speed airflow cools the inside of the motor, to thus greatly increase an inhalation efficiency in comparison with the conventional art and decrease electric power consumption. As a result, since an amount of heat generated from a power drive device is reduced, the vacuum inhaling apparatus can be cooled without having a separate heat radiator, for example, aluminum heat radiation fins.

Therefore, the vacuum inhaling apparatus according to the present invention may not employ an aluminum heat radiation structure whose volume is large and weight is increased and which is needed to cool an electric power drive device differently from the conventional art, and thus may be designed into an internal type in which an IPM motor is located in a space formed between an air guide and a control PCB.

In addition, in the case of the IPM motor according to this invention, the lines of the magnetic forces which are respectively emitted from the permanent magnets and the lines of the magnetic forces which are respectively converged into the permanent magnets accomplish a uniformly distributed pattern. A magnetic flux density distribution in a gap between a rotor and a stator becomes uniform, to thereby achieve improvement of an efficiency of the motor and reduction of the torque ripple.

In the present invention, the number of slots is reduced into the minimum number necessary for three phase drive. Accordingly, a path through which inhaled air passes is designed in the inside of the stator, to thus minimize diameter of the IPM motor. As a result, the vacuum inhaling apparatus is also of a compact structure, to thus achieve miniaturization of a cleaner.

### DESCRIPTION OF DRAWINGS

The above and other objects and advantages of the present invention will become more apparent by describing the preferred embodiments thereof in detail with reference to the accompanying drawings in which:

FIG. 1 is a cross-sectional view showing a vacuum inhaling apparatus for a cleaner according to a preferred embodiment of the present invention;

FIGS. 2A and 2B are a plan view and a bottom view showing an upper housing of the vacuum inhaling apparatus according to the preferred embodiment of the present invention, respectively;

FIG. 3 is a plan view showing an intermediate housing of the vacuum inhaling apparatus according to the preferred embodiment of the present invention;

FIGS. 4A through 4C are a plan view, a bottom view, and a side view showing a PCB cover of the vacuum inhaling apparatus according to the preferred embodiment of the present invention, respectively;

FIGS. 5A and 5B are a side view showing an external appearance of a rotor of an IPM motor according to an embodiment of the present invention, and a cross-sectional view cut along the circumferential direction of the rotor of the IPM motor according to the present invention, respectively;

FIGS. 5C and 5D are a partially enlarged view of the rotor of FIG. 5B and a perspective view showing a permanent magnet of FIG. 5B;

FIGS. 6A and 6B are a plan view and a side view showing a stator according to the present invention, respectively;

FIG. 7 is a diagram showing a magnetic flow path between a rotor and a stator in an IPM motor according to the present invention; and

FIG. 8 is a diagram showing a modified example of a stator core according to the present invention.

### BEST MODE

Hereinbelow, an interior permanent magnet IPM motor and a vacuum inhalation apparatus using the same according to the present invention will be described with reference to the accompanying drawings. Like reference numerals denote like elements through the following embodiments. However, the detailed description of the relevant known functions or structures will be omitted when operational principles of the preferred embodiments of the present invention are described.

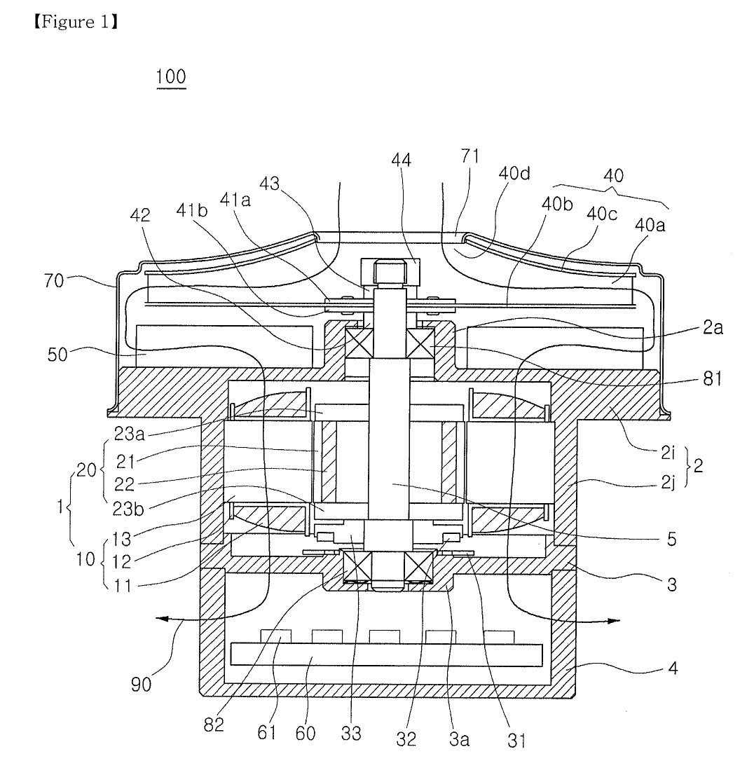

FIG. 1 is a cross-sectional view showing a vacuum inhaling apparatus for a vacuum cleaner according to a preferred embodiment of the present invention.

Referring to FIG. 1, the vacuum inhaling apparatus 100 according to the embodiment of the present invention includes: an IPM (Interior Permanent Magnet) motor 1 including a stator 10 and a rotor 20, which generates a rotational force; an upper housing 2 which protects the upper portion and the outer circumferential surface of the IPM motor 1; an intermediate housing 3 whose outer circumferential portion is fixedly combined with the lower end of the upper housing 2, and which supports the IPM motor 1; a rotating shaft 5 which is fixedly combined at the center of the rotor 20 to then be rotated; an impeller 40 which is arranged at the upper side of the rotor 20, and which is fixedly combined on the upper end of the rotating shaft 5, to thus generate an inhalation force via a circular inlet 40d located at the center of an upper plate 40c of the impeller as the rotating shaft 5 is rotated; an air guide 50 which is arranged between the impeller 40 and the IPM motor 1, and which guides an airflow of introduced air inhaled by the inhalation force generated by the impeller 40 into the inside of the IPM motor 1; and a cover 70 an air inlet 71 located at the central portion of which is extended to the circular inlet 40d of the impeller 40 and whose outer circumferential portion surrounds the impeller 40 and the air guide 50 and simultaneously is extended so as to form an air passage path to then be combined with the outer circumferential portion of the air guide 50.

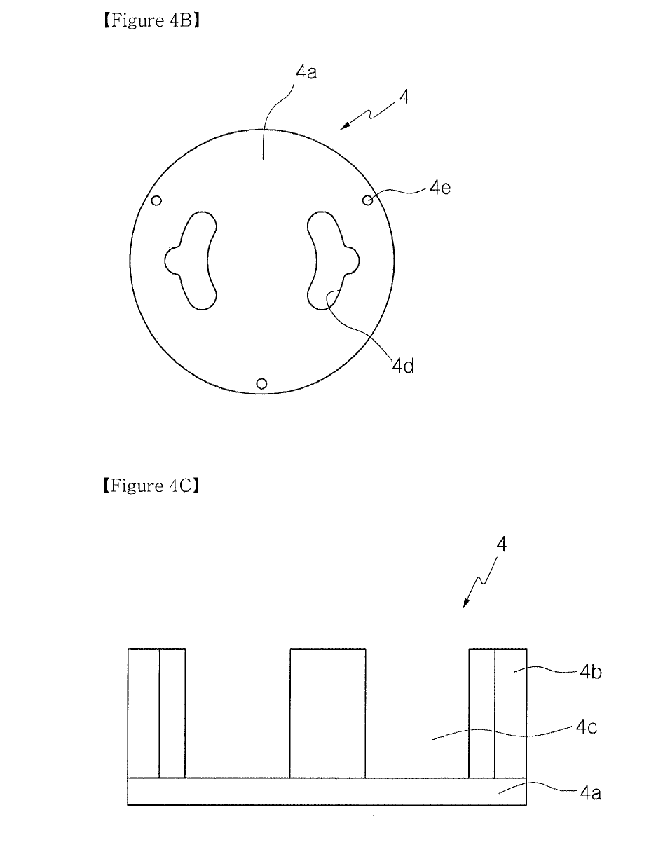

In addition, the vacuum inhaling apparatus 100 includes: a control PCB 60 on which circuit elements 61 such as transistor devices are mounted and which applies a drive voltage for the IPM motor 1; and a PCB cover 4 whose leading ends are combined with the intermediate housing 3 and on the bottom of which the control PCB 60 is mounted to protect the control PCB 60, and which exhausts introduced air flowing in the motor 1 through an outlet 4c (FIG. 4C) formed at the side surface thereof.

The structure and function of the respective compositional components of the vacuum inhaling apparatus 100 will be described below in detail.

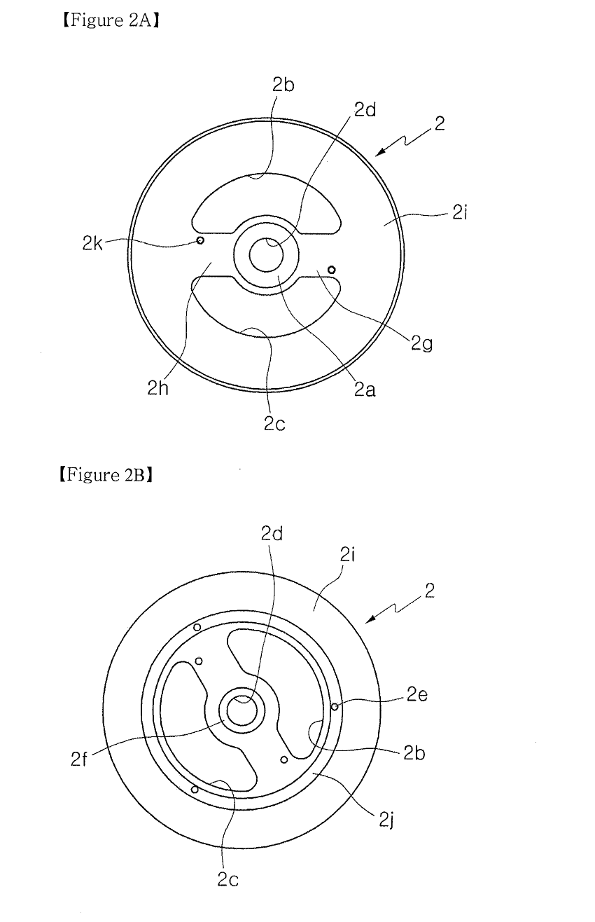

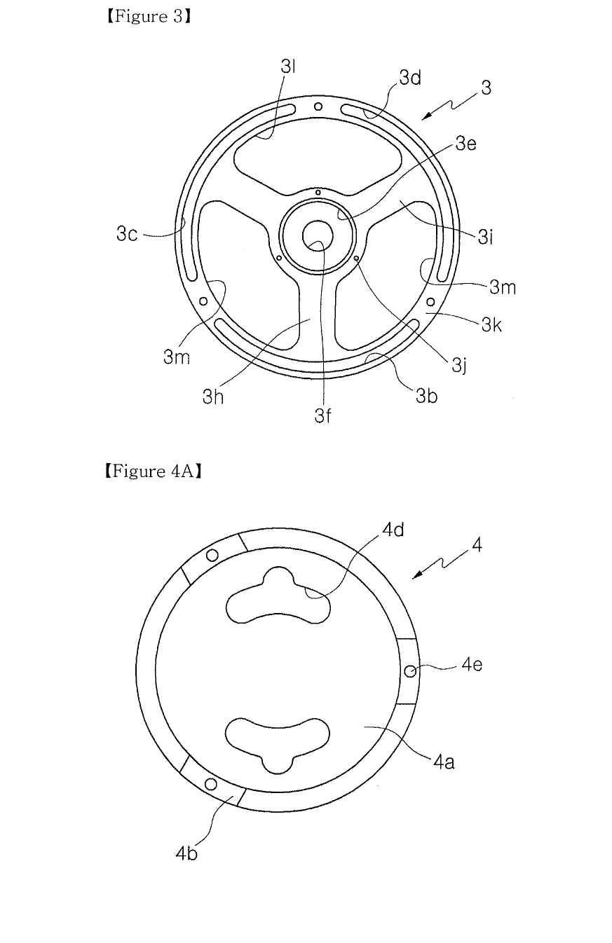

In the IPM motor 1, first and second bearings 81 and 82 are installed in the upper housing 2 which is illustrated in FIGS. 2A and 2B and the intermediate housing 3 which is illustrated in FIG. 3, respectively. The stator 10 is fixedly installed in the inner circumferential portion of the upper housing 2 and the rotor 20 is arranged in a space formed at the center of the stator 10. The rotating shaft 5 which is combined at the central portion of the rotor 20 is rotatably supported to the first and second bearings 81 and 82.

In the case of the upper housing 2 as illustrated in FIGS. 2A and 2B, a bearing accommodation groove 2f accommodating the first bearing 81 is formed in the inner circumferential portion of an annular protrusion 2a which is protrudingly formed at the central portion of the air guide 50, and a circular throughhole 2d through which the rotating shaft 5 passes is formed at the center of the annular protrusion 2a. In addition, a pair of throughholes 2b and 2c which makes the introduced air which has been guided by the air guide 50 introduced into the inside of the motor 1 are formed at one side and the other side of the annular protrusion 2a, in an approximately semi-circular shape.

The circular protrusion 2a is supported to an annular body 2i by a pair of connections 2g and 2h, and a cylindrical portion 2j surrounding the side surface of the stator 20 is extended on the back of the annular body 2i. Small holes 2k formed in the pair of the connectors 2g and 2h are used to fix the stator 20, and small holes 2k formed in the cylindrical portion 2j are used to fix the intermediate housing 3 and the PCB cover 4 to each other.

In the case of the intermediate housing 3 as illustrated in FIG. 3, a bearing accommodation groove 3e accommodating the second bearing 82 is formed in the inner circumferential portion of the circular protrusion 3a that is protrudingly formed toward the inner side of the PCB cover 4, and a circular throughhole 3f through which the lower end of the rotating shaft 5 passes is formed at the center of the circular protrusion 3a. Three throughholes 3l-3n which exhausts air to the outside via the stator 10 of the motor 1 are formed in an approximately 180° circular arc shape, respectively.

In order to make the throughholes 3I-3n form an approximately 180° circular arc shape, respectively, the circular protrusion 3a is supported to the annular body 3k by three connectors 3g-3i, and three elongate holes 3b-3d are formed on the upper portion of the annular body 3k along the annular body 3k.

The elongate holes 3b-3d are holes through which clamping bolts or rivets that are engaged into the small holes 2e formed in the cylindrical portion of the upper housing 2 pass from the PCB cover 4, and the intermediate housing 3 has a structure that the installation position of the intermediate housing 3 may be changed within the scope of the elongate holes 3b-3d.

Fixing holes 3j which fix an auxiliary PCB 31 to be described later are formed on the upper surface of the outside of the bearing accommodation groove 3e. Three magnetic sensors, for example, hall sensors for detecting the rotational position of the rotor 20 are disposed on the auxiliary PCB 31 which is fixed to the fixing holes 3j. A sensing magnet bracket 33 is supported to the rotating shaft at the lower side of the rotor 20 opposing the auxiliary PCB 31, and an annular sensing magnet 32 which is magnetized to have the same magnetic pole as that of the magnet included in the rotor 20 is installed in the outer circumferential portion of the sensing magnet bracket 33.

Therefore, when the rotor 20 rotates, the sensing magnet bracket 33 and the sensing magnet 32 also rotate. Accordingly, the three hall sensors installed in the auxiliary PCB 31 can detect the rotational position of the rotor 20. The rotor rotational position signals output from the hall sensors determine a timing at which a drive signal is applied for the stator coil.

The hall sensors are position-set to apply a drive signal for the stator coil at a timing that the least electric current flows in the stator, to thereby obtain a high efficiency. The elongate holes 3b-3d of the intermediate housing 3 are used to finely control the intermediate housing 3 so that the hall sensors detect the rotational position of the rotor 20 at the above-described timing.

As illustrated in FIGS. 4A to 4C, the PCB cover 4 includes a circular baseplate 4a and three legs 4b that is vertically protruded from the circular baseplate 4a. Spaces between the three legs 4b form outlets 4c which exhaust the introduced air which is exhausted via the IPM motor 1.

A pair of set fixing holes 4d which are used to fix the vacuum inhaling apparatus 100 in a main frame of a cleaner are formed in the baseplate 4a. Throughholes 4e which are used to fix the PCB cover 4 to the intermediate housing 3 and the upper housing 2 are formed in the three legs 4b, respectively.

On the baseplate 4a of the PCB cover 4 are installed the control PCB 60 on which the circuit elements 61 of the drive circuit which applies the drive voltage to the stator 10 are mounted as shown in FIG. 1, using fixing units (not shown) with an interval from the baseplate 4a of the PCB cover 4. An electric power drive device (not shown) for driving a motor may be disposed in a space between the baseplate 4a of the PCB cover 4 and the control PCB 60.

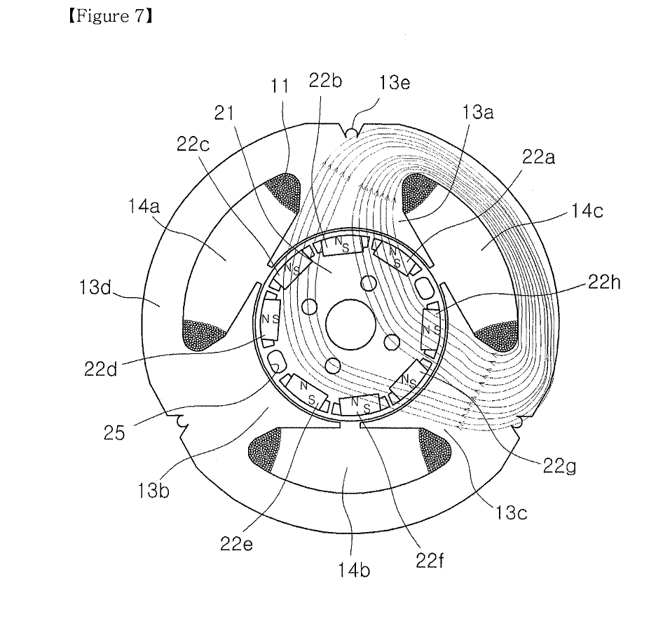

Meanwhile, as shown in FIGS. 1 and 7, the IPM motor 1 which is used in the vacuum inhaling apparatus 100 according to this invention includes: a stator 10 which is formed of a number of magnetic iron plates which are overlaid one another in a cylinder shape, and has three tees 13a-13c which are protruded in an approximately “T” shape so as to form three slots 14a-14c on the inner circumferential wall of the stator 10, and a stator coil 11 which is wound around the slots 14a-14c so as to magnetically generate N-poles and S-poles of three phases; and a rotor 20 which is formed of a number of magnetic iron plates which are overlaid one another, like the stator 10, and which is rotatably disposed with a certain gap from and in the inside of the stator 10.

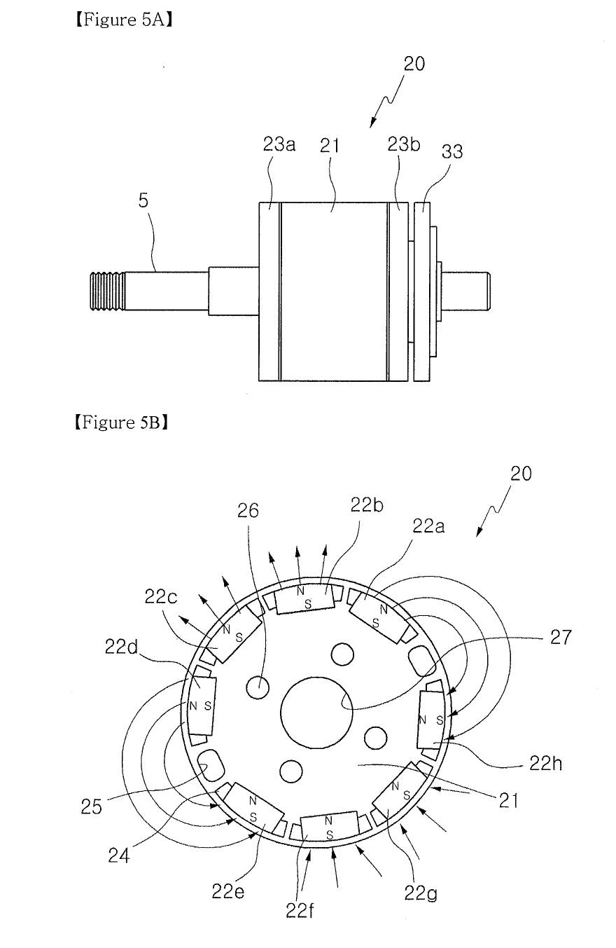

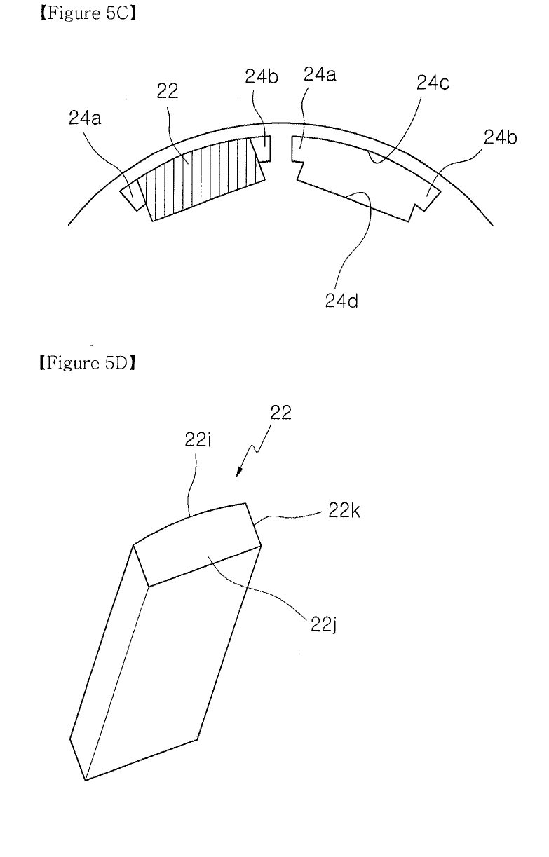

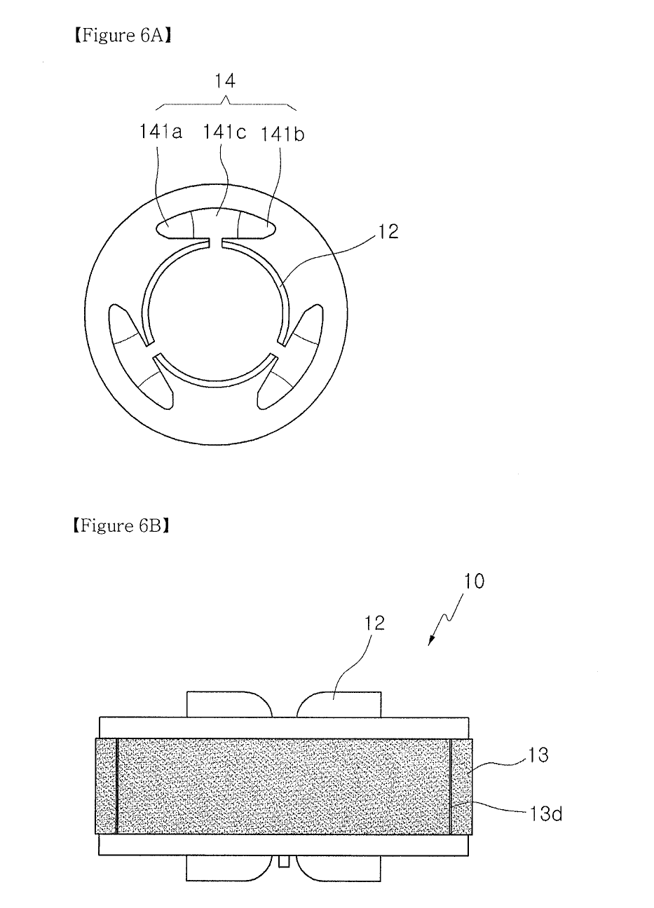

FIGS. 5A and 5B are a side view showing an external appearance of a rotor of an IPM motor according to an embodiment of the present invention, and a cross-sectional view cut along the circumferential direction of the rotor of the IPM motor according to the present invention, respectively. FIGS. 6A and 6B are a plan view and a side view showing a stator according to the present invention, respectively.

First, referring to FIGS. 5A and 5B, the rotor 20 of the IPM motor includes: a rotor core 21 which is formed of a number of magnetic iron plates which are overlaid one another; a shaft hole 27 which is axially formed at the central portion of the rotor core 21; eight permanent magnet insertion holes 24 which are formed on an identical circumference on the outer side of the central portion of the rotor core 21; and eight permanent magnet 22a-22h which are fitted into the eight permanent magnet insertion holes 24. A rotating shaft 5 that generates a rotational drive force while rotating with the rotor 20 is coupled with the shaft hole 27.

The respective magnetic iron plates forming the rotor core 21 are combined with one another, by inserting respective rivets into a number of coupling holes 26 which are formed between the shaft hole 27 of the rotor 20 and the permanent magnet insertion holes 24. Balance weights 23a and 23b made of a circular non-magnetic material, for example, SUS (Steel Use Stainless) or Cu, are attached on the upper and lower portions of the rotor 20, in order to prevent leakage of axial magnetic flux, as well as simultaneously prevent secession of the permanent magnets 22a-22h which are inserted into the rotor core 21 and an eccentricity of the rotor 20, during high speed rotation. The balance weights 23a and 23b are used for removing and eccentricity by providing fine grooves on the outer circumferential surface when the eccentricity occurs during high speed rotation of the rotor 20, respectively.

The sensing magnet bracket 33 that fixes the sensing magnet 32 is formed at the lower portion of the balance weight 23b and the sensing magnet 32 is combined on the lower portion of the sensing magnet bracket 33.

The permanent magnets 22a-22h are preferably implemented using magnets made of Nd having a high magnetic flux density, and are magnetized in a radial direction of the rotor 20, to thus form an anode electrode, and to accordingly generate permanent magnet torques by interaction between the magnetic flux by the permanent magnets 22a-22h and the rotating magnetic field formed by the electric current flowing in the coil 11 of the stator 10.

In this case, the first group of the four permanent magnets 22a-22d are magnetized to have a totally 2-pole magnetic pole structure so that the circumferential surfaces thereof are set to be N-poles, respectively and the inner side surfaces thereof are set to be S-poles, respectively in the diametrical direction. To the contrary to the first group of the four permanent magnets 22a-22d, the second group of the remaining four permanent magnets 22e-22h are magnetized so that the circumferential surfaces thereof are set to be S-poles, respectively and the inner side surfaces thereof are set to be N-poles, respectively. As a result, in view of the circumferential surfaces thereof, the first group of the permanent magnets 22a-22d play a role of a totally N-pole magnet, and the second group of the permanent magnets 22e-22h play a role of a totally 5-pole magnet.

For this purpose, a leakage prevention hole, that is, a spacer 25 is formed between the first group of the permanent magnets 22a-22d and the second group of the permanent magnets 22e-22h, respectively in order to prevent leakage of the magnetic flux in a lateral direction, that is, in a circumferential direction. The spacer 25 makes magnetoresistance large to thus prevent magnetic flux leakage.

In addition, in the case of the rotor 20 as shown in FIG. 5C, the outer circumferential surface 24c of the permanent magnet insertion hole 24 into which the respective permanent magnets 22a-22h are inserted is established equally to a curvature of the outer circumferential surface of the rotor core 21, and the inner side surface 24d opposing the outer circumferential surface of the permanent magnet insertion hole 24 is formed of a linear shape. At both the side surfaces of the permanent magnet insertion hole 24 are partially formed empty spaces into which the respective permanent magnets 22a-22h are not inserted, and small-sized spacers 24a and 24b are additionally protrudingly formed in order to prevent magnetic flux leakage, respectively. In this case, the diametrical lengths of the spacers 24a and 24b are formed relatively shorter than those of the portion into which the permanent magnets 22a-22h are inserted.

Moreover, as shown in FIGS. 5C and 5D, the outer circumferential surfaces 22i of the respective permanent magnets 22a-22h is established equally to a curvature of the outer circumferential surface of the permanent magnet insertion hole 24, and the inner side surfaces 22j opposing the outer circumferential surfaces of the respective permanent magnets 22a-22h are formed of a linear shape and have a shape corresponding to the permanent magnet insertion hole 24. Both the side surfaces 22k of the respective permanent magnets 22a-22h have a bar shape which is established perpendicularly with the inner side surface 22j, respectively. Therefore, the permanent magnet 22a-22h that are inserted into the permanent magnet insertion hole 24 are limited to move in a circumferential direction and in a diametrical direction.

As described above, the outer circumferential surfaces of the permanent magnets 22a-22h according to the present invention are formed relatively longer than the inner side surfaces 22j thereof. At both the side surfaces of the permanent magnets 22a-22h are formed small-sized spacers 24a and 24b in order to prevent magnetic flux leakage. As a result, a pattern that the magnetic fluxes that are produced from the permanent magnets 22a-22d are concentrated on both side corners of the permanent magnets 22a-22d, to thus emit the line of the magnetic force, and are concentrated on both side corners of the permanent magnets 22e-22h, to thus converge the line of the magnetic force, is corrected. Accordingly, as shown in FIG. 5B, the line of the magnetic force emitted from the permanent magnets 22a-22d and the line of the magnetic force converged to the permanent magnets 22e-22h are corrected to form a uniformly distributed pattern.

As a result, the IPM motor 1 according to this invention makes the magnetic flux density distribution in the gap between the rotor 20 and the stator 10 uniform, to thereby improve efficiency of the electric motor and reduce torque ripple.

In addition, the permanent magnet insertion hole 24 is disposed in the closest relationship with respect to the outer circumferential surface of the rotor core 21, and thus an amount of the magnetic flux emitted from the permanent magnets is increased, to thereby achieve an increase of torque.

Meanwhile, referring to FIGS. 1, 6A, 6B and 7, the stator 10 according to this invention includes: a stator core 13 having an annular body 13d that is formed of a number of magnetic iron plates which are overlaid on one another in a cylindrical shape and are integrated with one another by welds and three tees 13a-13c that are protruded in an approximately “T” shape so as to form three slots 14a-14c on the inner circumferential wall of the of the annular body 13d; and a stator coil 11 that is wound around the slots 14a-14c to magnetically generate N-poles and S-poles of three phases. Three welding grooves 13e are provided on the outer circumferential surface of the annular body 13d in order to weld the number of the overlaid magnetic iron plates.

In this case, the annular body 13d and the tees 13a-13c form an integral type stator core 13. As shown in FIGS. 6A and 6B, except for the outer circumferential surface of the annular body 13d and the inner circumferential surface of the tees 13a-13c, a bobbin 12 made of insulation resin is integrally formed with the inner circumferential surface, the upper and lower surfaces of the annular body 13d around which the stator coil 11 is wound and the upper and lower surfaces of the tees 13a-13c.

The three slots 14 which are formed by the three tees 13a-13c are partitioned into first and second regions 141a and 141b around which the stator coil 11 is wound and a third region 141c around which no coil is wound. The third region 141c around which no coil is wound accomplishes a passage route of air inhaled through the impeller 40. In this case, the stator 10 is preferably designed so that the third region 141c around which no coil is wound coincides with a pair of throughhole 2b and 2c of the upper housing 2 and throughholes 3l-3n of the intermediate housing 3.

In order to use the third region 141c around which no coil is wound in the slot 14 as the passage route of the inhaled air in the stator 10, the number of slots has been designed to be the minimum number, that is, three which is needed to three phase drive. In all the cases of the conventional IPM motors, slots are formed, but the number of slots is decreased in the present invention to thereby enable winding of the coil 11 to facilitate.

As described above, the vacuum inhaling apparatus 100 according to this invention is formed to make the passage route of the inhaled air pass through the inside of the IPM motor 1 so that the inhaled air is discharged into the upper space of the control PCB 60, using the slots 14 of the stator 10. Accordingly, as shown in FIGS. 1 and 7, it has been possible to minimize diameter of the IPM motor 1. As a result, the vacuum inhaling apparatus 100 has a compact structure on the whole and minimizes space of a cleaner where the vacuum inhaling apparatus occupies.

In addition, the vacuum inhaling apparatus 100 establishes the passage route of the inhaled air into a path of air-cooling the inside of the stator and the circuit elements 61 mounted on the control PCB 60. Accordingly, the inside of the stator and the circuit elements 61 mounted on the control PCB 60 may be cooled without having a separate heat radiator.

FIG. 7 shows the liner of the magnetic force, that is, a magnetic flow path which is formed between a rotor 20 in which eight permanent magnets 22a-22h are set to be respectively different magnetic poles to then be divided into first and second groups, so as to have a totally 2-pole magnetic pole structure, and a stator 10 in which the stator coil 11 of a three phase drive system is wound around the three slots 14a-14c.

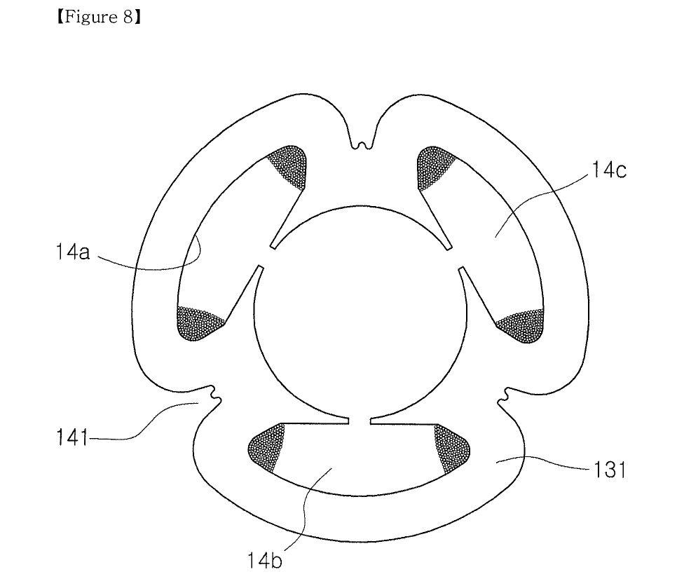

FIG. 8 is a diagram showing a modified example of a stator core according to the present invention. The stator core according to the modification of the present invention is same as that of the above-described embodiment of the present invention in a point of view that three slots 14a-14c are formed by three “T”-shaped tees, but the former differs from the latter from the viewpoint that grooves 141 are formed on the outer circumferential surface of the body 131 that correspond to the tees, to thus additionally form a passage route of inhaled air in a space between the inner circumferential surface of the upper housing 2.

Hereinbelow, the impeller 40, the air guide 50 and the cover 70 which are arranged at the upper side of the IPM motor 1, will be described in detail.

A number of guide plates which are formed in a spiral shape are disposed in the central direction so that introduced air inhaled by the inhalation force of the impeller 40 can be guided into the inside of the IPM motor 1.

In addition, the impeller 40 arranged at the upper portion of the air guide 50 includes: an annular upper plate 40c on the upper side of which a circular inlet 40d is projected with a predetermined tilt angle; a circular lower plate 40b which is disposed in opposition to the upper plate 40c and with the central portion of which the rotating shaft 10 of the rotor 20 is combined; and a number of guide vanes 40a which are disposed in a spiral partition form between the upper plate 40c and the lower plate 40b to thus form an air passage route which guides air that is inhaled via the inlet 40d during rotation to the circumferential portion.

The impeller 40 is coupled with the rotor 20, for power transmission. For this purpose, a pair of upper and lower impeller washers 41a and 41b are combined on the upper and lower surfaces of the central portion of the lower plate 40b of the impeller 40, and are fixed using a rivetting method, etc. The rotating shaft 5 is combined into the throughhole formed at the centers of the lower plate 40b of the impeller 40 and the upper and lower impeller washers 41a and 41b, respectively.

In addition, a poly slider 42 is inserted between the lower impeller washer 41b and the first bearing 81, the impeller bushing 43 is combined on the upper portion of the upper impeller washer 41b, and the fixing nut 44 is screw-connected with the upper portion of the impeller bushing 43.

The fixing nut 43 plays a role of preventing secession of the impeller bushing 43 and a pair of the impeller washers 41a and 41b and further strengthening a coupling force between the rotating shaft 5 and the impeller 40.

Therefore, the impeller 40 is configured so that the impeller bushing 43 compressively supports a pair of the impeller washers 41a and 41b to the central portion of the lower plate 40b of the impeller 40 according to tightening of the fixing nut 44, to thereby be closely fixed rotatably to the first bearing 81 through the poly slider 42. As a result, the impeller 40 is rotated with the rotor 20 without sliding during rotation of the rotor 20. Thus, the rotational force of the rotor 20 is effectively transferred to the impeller 40.

In addition, a cover 70 that protects the inner components of the vacuum inhaling apparatus 100 and forms an external appearance is combined on the upper portion of the impeller 40, and the lower portion of the cover 70 is combined with the outer circumferential portion of the upper housing 2. A circular inlet 71 via which air is inhaled is formed at the central portion of the cover 70. The inner circumferential portion of the cover 70 is extensively formed toward the inlet 40d of the impeller 40, to thus guide the inhaled external air to the inlet 40d of the impeller 40. In addition, the lower portion of the cover 70 is combined with the outer circumferential portion of the upper housing 2 in a sealed form. Accordingly, the cylindrical lower portion of the cover 70 which keeps a predetermined gap from the impeller 40 and the outer circumferential portion of the air guide 50, forms an air passage route which guides the introduced air which is exhausted from the impeller 40 to spaces formed between a number of guide plates of the air guide 50.

If a drive voltage is applied to the stator coil 11 from the control PCB 60 to the IPM motor 1 in the vacuum inhaling apparatus 100 of the cleaner having the above-described configuration, the impeller 40 is rotated at high speed according to rotation of the rotor 20. If the impeller 40 rotates at high speed, air existing in the inside of impeller 40 is reflected from the inner circumferential portion of the cover 70 by action of a number of the guide vanes 40 which are spirally disposed in the inside of the impeller 40, and then is introduced into the central portion along the spiral air guide 50. Then, the introduced air is reflected by a circular protrusion 2a of the upper housing 2 and thus quickly exhausted into the inside of the stator 10 of the IPM motor 1, to thereby generate a strong negative pressure in the inlet 40d of the impeller 40.

If the strong negative pressure occurs, external air is inhaled through the circular inlet 71 of the cover 70, and then is strongly exhausted to the air guide 50 by the impeller 40. The pressurized air exhausted to the air guide 50 is introduced into the inside of the motor 1 through the inhalation hole 2c of the upper housing 2. The introduced air which is introduced into the inside of the motor 1 passes through the slots 14a-14c of the stator 10 and the throughholes 3l-3n of the intermediate housing 3, and is supplied to the upper surface of the control PCB 60. Thereafter, the introduced air is exhausted to the outside of the vacuum inhaling apparatus 100 via the outlet 4c formed between the three legs 4b of the PCB cover 4.

Here, the vacuum cleaner inhales foreign matters with air into the inside of the vacuum cleaner, using a strong vacuum inhalation force that is generated from the inlet 71 of the vacuum inhaling apparatus 100, and collects dust in a dust collector formed in the front end of the vacuum inhaling apparatus 100, to then exhaust the air from which the foreign matters have been removed to the outside of the vacuum inhaling apparatus 100.

As described above, a vacuum inhaling apparatus 100 according to the present invention is configured to make an air passage route 90 of the shortest distance via which external air passes curved in which the external air passes through a circular inlet 71 of a cover 70, an impeller 40, an air guide 50, a stator 10 of a motor 1, and an outlet 4c of a PCB cover 4, in turn, to thus make the vacuum inhaling apparatus established to have a natural airflow channel, and to thereby minimize a frictional resistance.

In addition, introduced air having passed through an upper housing 2 moves to the inside of the motor, to thus air-cool circuit elements 61 such as power drive devices which are mounted on the stator 10 and the control PCB 60, and an air exhaustion path is established into the outlet 4c of the PCB cover 4. Accordingly, the vacuum inhaling apparatus 100 can be cooled without having a separate heat radiator.

Thus, the cleaner employing the vacuum inhaling apparatus according to the present invention causes little heat generation by the inner electric current in the rotor 20, and the heat generated from the vacuum inhaling apparatus 100 can be cooled at an air cooling mode.

Moreover, a rotational force of the rotor 20 is effectively transferred to the impeller 40 in the vacuum inhaling apparatus 100 according to the present invention, and thus air passes through an airflow path having a short air passage route 90 and a small amount of frictional resistance. Accordingly, high speed airflow cools the inside of the motor, to thus greatly increase an inhalation efficiency in comparison with the conventional art and decrease electric power consumption. As a result, since an amount of heat generated from a power drive device is reduced, the vacuum inhaling apparatus can be cooled without having a separate heat radiator, for example, aluminum heat radiation fins.

Therefore, the vacuum inhaling apparatus 100 according to the present invention may not employ an aluminum heat radiation structure whose volume is large and weight is increased and which is needed to cool an electric power drive device differently from the conventional art, and thus may be designed into an internal type in which an IPM motor 1 is located in a space formed between the air guide 50 and the control PCB 60.

In addition, in the case of the IPM motor 1 according to this invention, the lines of the magnetic forces which are respectively emitted from the permanent magnets 22a-22d and the lines of the magnetic forces which are respectively converged into the permanent magnets 22e-22h accomplish a uniformly distributed pattern. A magnetic flux density distribution in a gap between the rotor 20 and the stator 10 becomes uniform, to thereby achieve improvement of an efficiency of the motor and reduction of the torque ripple.

In the present invention, the number of slots is reduced into the minimum number necessary for three phase drive. Accordingly, a path through which inhaled air passes is designed in the inside of the stator 10, to thus minimize diameter of the IPM motor 1. As a result, the vacuum inhaling apparatus 100 is also of a compact structure, to thus achieve miniaturization of a cleaner.

### MODE FOR INVENTION

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

### INDUSTRIAL APPLICABILITY

The present invention can implement an IPM motor into a compact structure, and realize high speed of 40,000 RPM and a large power output of 2,400 W in the form of a BLDC motor. Accordingly, the present invention can be applied to a vacuum cleaner, a battery car, etc.

1. A vacuum inhaling apparatus comprising:
an IPM (Interior Permanent Magnet) motor including: a stator having a number of teeth which are protruded so as to form a number of slots on the inner circumferential wall of a cylindrical body, and a stator coil which is wound around the slots; and an IPM (Interior Permanent Magnet) type rotor having a rotor core which is rotatably disposed spaced by a certain gap in the inside of the stator, and a number of permanent magnets which are fitted into a number of permanent magnet insertion holes formed on the circumference of the rotor core;
a cylindrical upper housing which protects the upper portion and the outer circumferential surface of the IPM motor and which has a number of first throughholes through which introduced air passes;
an intermediate housing whose outer circumferential portion is combined with the lower end of the upper housing, and which supports the IPM motor and which has a number of second throughholes through which the introduced air passes;
a rotating shaft which is fixedly combined at the center of the rotor core and whose both ends are rotatably supported to the upper and intermediate housings;
an impeller which is combined on the upper end of the rotating shaft, to thus generate an inhalation force as the rotating shaft is rotated;
a cover at the upper end of which is combined with the upper housing while surrounding the impeller to thus guide the introduced air in the central direction; and
an air guide which is arranged between the impeller and the upper housing, and which guides the introduced air guided in the central direction into the first throughholes of the upper housing.

2. The vacuum inhaling apparatus according to claim 1, wherein an annular protrusion which guides the introduced air introduced in the central direction by the air guide into the first throughholes of the upper housing, and on the inner circumferential portion of which a first bearing accommodation groove is formed, is protrudingly formed from the center of the upper housing to the center of the air guide.

3. The vacuum inhaling apparatus according to claim 2, further comprising:
a first bearing which is accommodated in the first bearing accommodation groove, to thus rotatably support one side of the rotating shaft; and
a second bearing which is accommodated in a second bearing accommodation groove that is provided in the intermediate housing, to thus rotatably support the rotating shaft.

4. (canceled)

5. The vacuum inhaling apparatus according to claim 1, further comprising:
first and second balance weights which are made of a non-magnetic material, and are respectively installed at both ends of the rotor so that the permanent magnets do not secede externally, to thus be used for preventing an eccentricity during high speed rotation of the motor;
a sensing magnet which is fixedly combined with a sensing magnet bracket which is installed at the lower end of the second balance weight, and which is magnetized in an identical pole at an identical position to those of the rotor, to thus be used for detecting a rotational position of the rotor; and
a hall sensor which is installed in the intermediate housing opposing the sensing magnet to detect a rotational position of the rotor from the sensing magnet.

6. The vacuum inhaling apparatus according to claim 5, wherein the intermediate housing on the outer circumferential portion of which a number of elongate holes are formed, and a position where the intermediate housing is combined with the upper housing is adjusted using the elongate holes, in order to determine a timing at which the hall sensor detects the rotational position of the rotor, in which the timing at which the hall sensor detects the rotational position of the rotor is established so that a drive signal for the stator coil can be applied at a timing at which the smallest amount of electric current flows in the stator coil.

7. The vacuum inhaling apparatus according to claim 1, wherein the number of the permanent magnets comprise a first group of permanent magnets whose circumferential surfaces are diametrically magnetized into an N-pole and arranged adjacently one another, and a second group of permanent magnets whose circumferential surfaces are diametrically magnetized into an S-pole and arranged adjacently one another, so as to have a totally 2-pole magnetic pole structure,
wherein first and second spacers are formed between the first group of the permanent magnets and the second group of the permanent magnets in order to prevent leakage of magnetic flux in a circumferential direction.

8. The vacuum inhaling apparatus according to claim 7, wherein the number of the permanent magnets are formed of a bar shape, respectively, the outer circumferential surfaces of which have substantially the same curvatures as the curvatures of the outer circumferential surfaces of the permanent magnet insertion holes, respectively, in the cross-sections of the permanent magnets.

9. The vacuum inhaling apparatus according to claim 1, wherein in both side surfaces of the permanent magnet insertion holes third and fourth spacers into which no permanent magnets are inserted are protrudingly formed in order to prevent leakage of the magnetic flux in the respective side directions.

10. The vacuum inhaling apparatus according to claim 1, wherein the IPM motor has a 2-pole, 3-slot structure.

11. (canceled)

12. An IPM (Interior Permanent Magnet) motor comprising:
a stator having a number of teeth which are protruded so as to form a number of slots on the inner circumferential wall of a cylindrical body, and a stator coil which is partially wound around the slots; and
an IPM (Interior Permanent Magnet) type rotor having a rotor core which is rotatably disposed spaced by a certain gap in the inside of the stator, and a number of permanent magnets which are fitted into a number of permanent magnet insertion holes formed on the circumference of the rotor core;
wherein the number of the permanent magnets comprise a first group of permanent magnets whose circumferential surfaces are diametrically magnetized into an N-pole and arranged adjacently one another, and a second group of permanent magnets whose circumferential surfaces are diametrically magnetized into an S-pole and arranged adjacently one another, so as to have a totally 2-pole magnetic pole structure.

13. The IPM motor according to claim 12, wherein the number of the slots formed in the stator are divided into first and second regions around which the stator coil is wound, respectively, and a third region formed between the first and second regions and around which the stator coil is not wound, and air is ventilated through the third region.

14. The IPM motor according to claim 12, wherein the number of the permanent magnets are formed of a bar shape, respectively, the outer circumferential surfaces of which holes have substantially the same curvatures as the curvatures of the outer circumferential surfaces of the permanent magnet insertion holes, respectively, in the cross-sections of the permanent magnets.

15. The IPM motor according to claim 12, further comprising:
a first housing which protects the upper portion and the outer circumferential surface of the IPM motor and which has a number of first throughholes through which introduced air passes; and
a second housing whose outer circumferential portion is combined with the lower end of the first housing, and which has a number of second throughholes through which the introduced air passes,
wherein both ends of the rotating shaft which is fixedly combined at the center of the rotor are rotatably supported to the first and second housings.

16. (canceled)

17. (canceled)

18. The IPM motor according to claim 12, wherein first and second spacers are formed between the first group of the permanent magnets and the second group of the permanent magnets, respectively, in order to prevent leakage of magnetic flux in a circumferential direction.

19. The IPM motor according to claim 12, wherein in both side surfaces of the permanent magnet insertion holes third and fourth spacers into which no permanent magnets are inserted are protrudingly formed in order to prevent leakage of the magnetic flux in the respective side directions.
